(19) United States
(12) Patent Application Publication
(10) Pub. No.: US 2018/0078337 A1
(43) Pub. Date: Mar. 22, 2018

(54) ORTHODONTIC DISCOMFORT REDUCTION USING HIGH FREQUENCY STIMULATION

(71) Applicant: Advanced Orthodontics and Education Association, LLC, Ossining, NY (US)

(72) Inventors: Bryce A. WAY, San Jose, CA (US); Richard JOHNSON, Briarcliff Manor, NY (US)

(73) Assignee: Advanced Orthodontics and Education Association, LLC, Ossining, NY (US)

(21) Appl. No.: 15/672,529

(22) Filed: Aug. 9, 2017

Related U.S. Application Data
(63) Continuation-in-part of application No. PCT/US2017/019767, filed on Feb. 27, 2017.
(60) Provisional application No. 62/300,705, filed on Feb. 26, 2016.

(51) Int. Cl. A61C 7/00; A61C 19/06; A61C 7/08

(52) U.S. Cl. CPC A61C 7/008; A61C 7/36; A61C 7/08; A61C 19/06

(57) ABSTRACT

A method and device for reducing oral discomfort in a mouth of a user using high frequency vibration (HFV) includes placing a proximal end of a mouthpiece intraorally into vibrational contact with a dentition of the user, activating a vibration unit so as to deliver vibration at a frequency higher than about 80 Hz to the dentition of the user, and removing the vibration unit after about 5 minutes, wherein oral discomfort is reduced compared to a time before activating the vibration unit.

### BACKGROUND

### Technical Field

The present disclosure generally relates to dental and orthodontic devices and methods. More particularly, and without limitation, the disclosed embodiments relate to devices, and methods for reducing oral discomfort using high frequency acceleration (HFA) or high frequency vibration (HFV).

### Background Description

Orthodontic treatment continues to grow in popularity among both teens and adults. While social stigmas associated with orthodontic treatment are in decline, many are still hesitant to consider treatment. The length of treatment time, and fear of pain associated with treatment are the most prevalent concerns cited as the barriers to treatment acceptance. Studies have demonstrated that 58.3% of the subjects cited orthodontic pain as their primary complaint, followed closely by treatment duration. One factor that contributes to the pain and discomfort felt by the patients is poor aligner seating. When the aligners are not adequately seated, the aligner tray can lose its grip around the patient's teeth, which results in improper distribution of forces on the teeth. Therefore, the patient's teeth can move in an unexpected or non-advantageous direction, thereby producing pain and discomfort for the patients. As competition for new patients continues to increase, successful practices continue to seek ways to differentiate their practice, while addressing these cited concerns of potential and existing patients.

Vibration in conjunction with orthodontic forces has been studied in various frequencies and force levels with mixed results (Woodhouse 2015 and Ottoson 1981). It appears that frequency and force appear to correlate with the therapeutic responses associated with vibration therapy (Lala 2016). Previous literature and studies have demonstrated that vibration at low frequency was not effective at reducing pain originating from teeth (Woodhouse 2015 and Lala 2016), where vibration at high frequency was (Ottoson 1981 and Lala 2016). A possible mechanism is the “gate control” theory, which suggests that pain can be reduced by simultaneous activation of nerve fibers that conduct non-noxious stimuli. Another possibility is that vibration may help relieve compression of the periodontal ligament (PDL), thus promoting normalized circulation (Long 2016). In addition, high frequency vibration may improve seating of the aligners, thereby eliminating unplanned and unwanted teeth movement, allowing better tracking of teeth movement, and ultimately reducing pain and discomfort.

Use of nonsteroidal anti-inflammatory drugs (NSAIDs) to manage pain conjunction with orthodontic tooth movement has been shown to decrease prostaglandin synthesis leading to a decrease in the inflammatory bone resorption process and may negatively impact tooth movement. Therefore, efforts to find ways to increase compliance and manage pain as it relates to patient treatment satisfaction, as well as ways to provide more efficient treatment continue, along with efforts to address perceived pain for patients reluctant to accept treatment.

To date, patient compliance with the use of vibration devices remains a potential issue. A study has cited patient compliance as an issue despite daily reminder calls throughout the trial period (Tan 2011). It is hypothesized that high frequency vibration in conjunction with a 5 minute treatment time will not interfere with a patient's schedule, and will be effective at reducing pain or discomfort, as compared to patients not receiving any vibration treatment.

Therefore, it would be advantageous to have a treatment method that could successfully reduce orthodontic pain or discomfort in a period of time shorter than 20 minutes in order to reduce interference with patients' personal schedules. It would, also, be advantageous to have a more efficient treatment method that increases patient compliance and successfully manages pain in order to increase patient treatment satisfaction.

### SUMMARY

The embodiments of the present disclosure include devices and methods for reducing oral discomfort in a mouth of a user. Advantageously, the exemplary embodiments provide a method of reducing oral discomfort using high frequency vibration while providing better user compliance rate.

According to an exemplary embodiment of the present disclosure, a method of reducing oral discomfort in a mouth of a user is provided. The method can include placing a proximal end of a mouthpiece intraorally into vibrational contact with a dentition of the user. The method can further include activating a vibration unit so as to deliver vibration at a frequency range of about 80 Hz to about 120 Hz to the dentition of the user. The vibration frequency can be, for example, from about 110 Hz to about 120 Hz, from about 100 Hz to about 110 Hz, from about 90 Hz to about 100 Hz, or from about 80 Hz to about 90 Hz. It is contemplated that in other embodiments, the frequency could be any value within the range of about 80 Hz to about 120 Hz, and that the vibration frequency could be adjusted during a treatment period. In one exemplary embodiment, the vibration frequency is about 100 Hz. The method can further include removing the vibration unit after a treatment period of less than about 20 minutes, wherein oral discomfort is reduced compared to a time before activating the vibration unit. The treatment period can be, for example, less than about 20 minutes, 15 minutes, 10 minutes, 6 minutes, 5 minutes, 4 minutes, or less. It is contemplated that in other embodiments the time period could be any value within the range of about 1 minute and 19 minutes daily, and that the daily total treatment time could be formed of a plurality of treatment sessions contributing to the daily total treatment time. In one exemplary embodiment, the daily total treatment time is about 5 minutes.

The method can further include, in some aspects, vibrating the vibration unit at an acceleration magnitude between about 0.03 G and about 0.2 G. The frequency or the acceleration magnitude of the vibration of the vibration unit can be adjustable. The method can further include, in another aspect, depressing a button on the vibration unit in order to activate or deactivate the vibration unit. The vibration unit can, also, be removed after the vibration unit automatically deactivates after about 5 minutes.

The method can be performed when the user is undergoing orthodontic treatment. For example, the user can be wearing bracket-and-wire braces, and the mouthpiece can be in direct contact with at least a portion of the dentition of the user. In another embodiment, the user can be wearing at least one aligner, and the mouthpiece can be in vibrational contact with at least a portion of the dentition of the user through the at least one aligner.

The method can further include removably coupling a distal end of the mouthpiece to a housing comprising the vibration unit before activating the vibration unit. In one aspect, the proximal end of the mouthpiece can be placed intraorally before activating the vibration unit. In another aspect, the vibration unit can be activated before placing the proximal end of the mouthpiece intraorally.

In general, in one aspect, a device for reducing oral discomfort in a mouth of a user using HFV includes a mouthpiece and a vibration unit. The mouthpiece may have a proximal end and a distal end. The proximal end of the mouthpiece can be placed intraorally into vibrational contact with a dentition of the user. The vibration unit can deliver vibration at a frequency range of about 80 Hz to 120 Hz to the dentition of the user after it has been activated. The vibration frequency can be, for example, from about 110 Hz to about 120 Hz, from about 100 Hz to about 110 Hz, from about 90 Hz to about 100 Hz, or from about 80 Hz to about 90 Hz. It is contemplated that in other embodiments, the frequency could be any value within the range of about 80 Hz to about 120 Hz, and that the vibration frequency could be adjusted during a treatment period. In one exemplary embodiment, the vibration frequency is about 100 Hz. The vibration unit can be removed after a treatment period of less than about 20 minutes per cycle. The oral discomfort can be reduced compared to a time before the activation of the vibration unit. The treatment period can be, for example, less than about 20 minutes, 15 minutes, 10 minutes, 6 minutes, 5 minutes, 4 minutes, or less. It is contemplated that in other embodiments the time period could be any value within the range of about 1 minute and 19 minutes daily, and that the daily total treatment time could be formed of a plurality of treatment sessions contributing to the daily total treatment time. In one exemplary embodiment, the daily total treatment time is about 5 minutes.

The device can further include, in some aspects, a vibration unit that can vibration at an acceleration magnitude between about 0.03 G and about 0.2 G. The frequency or the acceleration magnitude of the vibration of the vibration unit can be adjusted. The device can further include a button. The button can be depressed in order to activate or deactivate the vibration unit. In some aspects, the vibration unit can be removed after the vibration unit automatically deactivates after about 5 minutes.

In one aspect, the device can bused when the user is undergoing orthodontic treatment. For example, the user can be wearing bracket-and-wire braces, and the mouthpiece can be in direct contact with at least a portion of the dentition of the user. In another embodiment, the user can be wearing at least one aligner, and the mouthpiece can be in vibrational contact with at least a portion of the dentition of the user through the at least one aligner.

These and other embodiments can include one or more of the following features.

The mouthpiece in an exemplary embodiment can be a C-shaped mouthpiece, or of any other convenient shape. The mouthpiece can be applied to the occlusal surfaces, lingual surfaces, or labial surfaces of the teeth. The mouthpiece can also be applied to an aligner, braces, other orthodontic appliances, or any other oral appliance, in order to facilitate tooth movement or to reduce oral discomfort.

The housing comprising the vibration unit can include status lights to indicate, for example, when a 5-minute cycle is in progress, when a user presses a switch button before treatment is complete, when a 5-minute treatment cycle is interrupted and not completed within a 30-minute time window, when the device is plugged in to a power source, when the battery is low, when the device is fully charged, when the 5-minute treatment cycle is interrupted and the user plugs the device into a USB connection within the 30-minute time window, and when device is on/vibrating and the user plugs the device into a USB connection thereby stopping the vibration.

The housing comprising the vibration unit can further include a button configured to be depressed to power on or power off the device.

The housing comprising the vibration unit can further include a connection port configured to be removably coupled to a charging cable or a USB cable that is capable of further connecting the device to a remote device or a wall charging adapter. The device can be a hand-held device and can be rechargeable.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 shows a graph comparing the mean in-office pain ratings over a period of 5 minutes immediately following an orthodontic adjustment between an experimental (VPro5) group and a control group.

FIG. 2 shows a graph comparing the mean at-home pain ratings over a period of 7 days immediately following an orthodontic adjustment between an experimental (VPro5) group and a control group.

FIG. 3 is a perspective view of the mouthpiece of an exemplary device, according the embodiments of the present disclosure.

FIG. 4 is a partial perspective view of the housing comprising a vibration unit of an exemplary device, according to the embodiments of the present disclosure.

FIG. 5 is a perspective view of the exemplary device, according to the embodiments of the present disclosure.

FIG. 6 is a partial perspective view of the exemplary device of FIG. 5, according to the embodiments of the present disclosure.

FIG. 7 is a perspective view of the exemplary device of FIG. 5 with a charging cable configured to be removably coupled to the housing.

FIGS. 8A-8P each show the measurement of vibration of an exemplary typodont subject to vibration treatment by the exemplary device of FIG. 5 under different testing conditions.

FIGS. 9A-9P each show the measurement of vibration of an exemplary typodont subject to vibration treatment by a commercially available dental device under different testing conditions.

FIG. 10A graphically compares g-force measurements of a typodont with an aligner subject to vibration treatment by the exemplary device of FIG. 5 and an exemplary commercially available dental device.

FIG. 10B graphically compares g-force measurements of a typodont without an aligner subject to vibration treatment by the exemplary device of FIG. 5 and an exemplary commercially available dental device.

### DETAILED DESCRIPTION

A randomized, single blind, multi-center clinical trial was performed to assess the pain ratings of subjects receiving clear aligner treatment. The trial was approved by Chesapeake IRB Columbia, Md., USA, and the study planned to enroll 75 subjects from 4 study centers. All subjects were Orthodontic patients eligible for aligner treatment with a Class I or mild Class malocclusion needing minor lower incisor alignment. Subjects had at least one lower anterior tooth that required only anteroposterior movement of 1 mm (no extrusion, intrusion or rotation correction during the duration of the trial) and this anteroposterior movement was not blocked by adjacent teeth. Patients between 18 and 45 years of age were selected to decrease the possibility of effect of age on the rate of tooth movement. All racial and ethnic groups and both male and female subjects were considered for the study. All subjects were in good general health, and none had received periodontal therapy during the previous 6 months. After identifying patients that met the inclusion criteria, the Informed Consent form was reviewed and signed.

Subjects were randomly assigned to one of the 5 groups using block randomization: Control (subjects did not receive high frequency acceleration (HFA) treatment and changed aligners every 14 days for 4 aligners); Experimental 1 (subjects did not receive HFA treatment and changed aligners every 7 days for 4 aligners); Experimental 2 (subjects received HFA treatment and changed aligners every 7 days for 4 aligners); Experimental 3 (subjects did not receive HFA treatment and changed aligners every 5 days for 4 aligners); Experimental 4 (subjects received HFA treatment and changed aligners every 5 days for 4 aligners). Initially, a block of 5 subjects was used for randomization among the five groups. However, after 5 subjects in the Experimental 3 group showed non-tracking and reported pain during treatment, no additional subjects were assigned to the Experimental 3 group and no further samples were collected from the 5 subjects already assigned. Instead, randomization was continued among the Control and the remaining three Experimental groups (total sample collected was reduced to 65).

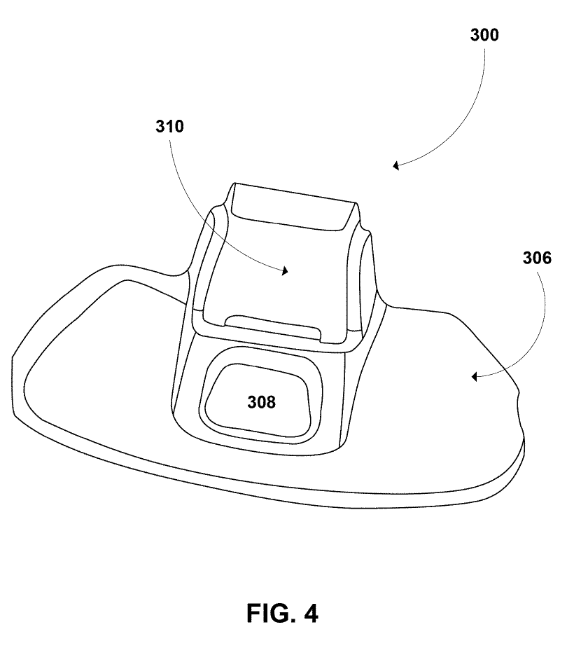

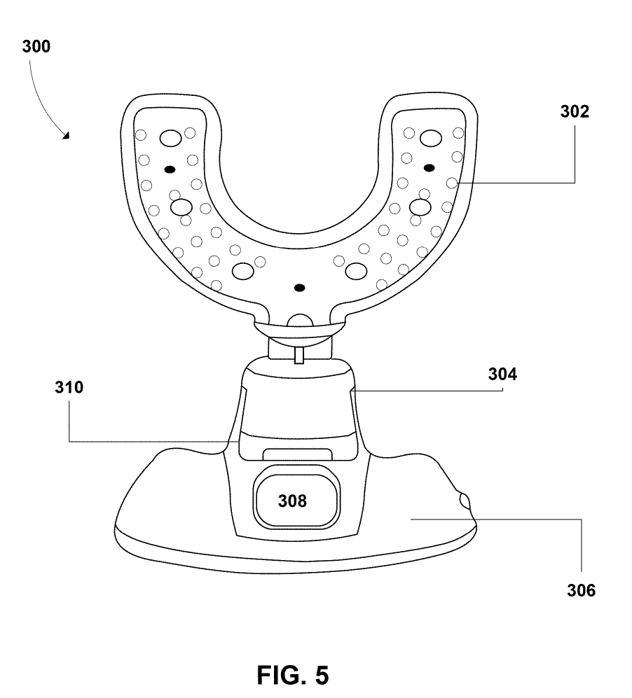

Patients used an exemplary embodiment of the device 300 in FIG. 5 to apply HFA treatment. Patients with the exemplary device 300 were instructed to use the device for at least 5 minutes per day. Patients that did not receive HFA were instructed to bite on the device 300 without turning on the machine. The variables in this study were the time intervals between aligners in the presence and absence of HFA application. Only the investigators analyzing the data were blinded to group assignment. All subjects completed routine orthodontic records including radiographs (lateral cephalograph and panoramic radiograph), facial and intraoral photographs and received a periodontal evaluation and caries clearance. Periodontal evaluation of subjects were performed by orthodontists and include (based on American Association of Periodontist' guidelines) full mouth probing depth (PD), plaque index (PI), and gingival index (GI) assessment.

At each visit during the study, an assessment of PD, PI, and GI was performed. In addition, at the start and end of the clinical trial period, intraoral photographs and digital scans were obtained. At the end of data collection, all patients continued to receive aligner treatment until treatment was finalized.

With mean of planned tooth movement being 57% with 20% SD, a sample size of 12 was required to achieve a power of 90% at p=0.05, and to detect minimal clinically relevant difference of 25% in the planned tooth movement of treatment group's means, 57% of planned tooth movement for standard Invisalign treatment vs. 83% of planned tooth movement for improved tracking in presence of the exemplary device 300. 15 subjects per group were enrolled to allow for approximately 20% dropouts from the study.

Patients assigned to the Experimental groups using the exemplary device 300 were asked to bite comfortably onto the device wafer with aligners in place for a total of 5 minutes per day, before sleeping, or for the longest time that aligner would be in their mouth without removal, with or without turning the device 300 on, depending on the group assignment. Compliance was reported daily by subjects by completing a form. Compliance forms were collected and reviewed at each office visit and if compliance was questionable (less than 20 hours of aligner wear per day or 1 day of no device application), the subject was dismissed from the study.

Subjects were asked to assess their level of discomfort at Days 1 and 3 after aligner use with a numeric rating scale. The patients were instructed to choose a number from 0 to 10 best described their pain (0 indicating ‘no pain’ and 10 indicating ‘worst possible pain’).

After confirming normal distribution of samples by the Shapiro-Wilk test, group comparisons were assessed by analysis of variance (ANOVA). Pairwise multiple comparison analysis was performed with the Tukey's post hoc test. In some experiments, paired and unpaired t-tests were used to compare the two groups. Two-tailed p-values were calculated, and p<0.05 was set as the level of statistical significance.

The final number of recruited subjects was 65 patients: 5 patients for limited enrollment Experimental 3 group, and 60 patients for the Control and remaining three Experimental groups. During the trial, 7 patients were disqualified due to lack of proper follow up (2 patients forgot to use the exemplary device 300 as prescribed, 3 did not wear the aligners for enough hours per day, and 2 did not follow instructions on changing aligners at specific time intervals based on their group assessment).

TABLE 1
Reported Pain and Discomfort (Mean ± SD)

| Group | Discomfort 1^{st} Day | Discomfort 3^{rd} Day |
|---|---|---|
| 14 days (Control) | 4.19 ± 0.71 | 2.42 ± 0.64 |
| 7 days (Experimental 1) | 4.6 ± 1.13 | 2.98 ±1.18 |
| 7 days + device 300 | 3.39 ± 1.35*^{,#} | 1.96 ± 0.9^{&} |
| (Experimental 2) | | |
| 5 days (Experimental 3) | N/A | N/A |
| 5 days + device 300 | 3.7 ± 0.95 | 2.21 ± 0.91 |
| (Experimental 4) | | |

*statistically significant difference compared with first day of the Experimental 1 group (p < 0.020)
^{#}statistically significant difference compared with the first day of Control group (p < 0.034)
^{&}statistically significant difference compared with the third day of the Experimental 1 group (p < 0.026).

Referring to Table 1 above, using a numerical rating scale, there was a statistically significant decrease in reported pain and discomfort on Day 1 of treatment between the Experimental 2 group and the Experimental 1 group (p<0.020) and Control group (p<0.034). No significant differences between the rest of the groups on the first day of aligner wear was observed. On Day 3 of aligner wear, the Experimental 2 group reported lower pain and discomfort levels compared with the Experimental 1 group, which was statistically significant (p<0.026). No difference among the rest of the groups was observed (p>0.05).

An aspect of aligner therapy that makes the appliance of aligners more attractive for patients is their association with less pain and discomfort. Comparative studies have shown that adults treated with aligners experienced less pain and fewer negative impacts on their lives during the first week of orthodontic treatment than did those treated with fixed appliances. In fact, the fixed appliance subjects took more pain medication during Days 2 and 3 of treatment.

In this study, a Numeric Rating Scale was used to evaluate the impact of VPro5 stimulation on pain and discomfort during clear aligner therapy. The results showed that, in fact, using the exemplary device 300 for only 5 minutes a day reduced reported pain and discomfort levels, for the first 3 days of treatment, which have been shown to be the critical period during which patients are more likely to take medication. In this study, none of the enrolled patients took any medication during the duration of the study. This is in agreement with previous studies that have recommended vibrational forces for reduction of pain for dental pain (Ottoson 1981) and tooth pain during orthodontics treatment (Marie 2003). However, some studies report no change in the perception of pain with a particular vibrational device, which emphasizes the differences in vibration produced by these devices (Woodhouse 2015 and Miles 2012). The pain-relieving effects of vibrational forces including HFA may be achieved by increasing vascularity and reducing areas of ischemic and through activation of large-diameter sensor nerve fibers. It can be concluded from this study that using the exemplary device 300 for 5 minutes per day significantly reduces the pain and discomfort during the first 3 days of clear aligner treatment.

Another retrospective, multi-centered, observational study was performed to investigate the pain reports of patients at 4 independent study centers. All subjects were orthodontic patients that received aligner treatment, with or without HFV treatment, and supplied in-office pain ratings.

Subject charts were selected sequentially from the clinical records patients that received aligner therapy, with no age restrictions. No racial and ethnic group requirements were considered. Subjects were selected from the clinical records in the period of Feb. 1, 2016 to Feb. 1, 2017, provided that the clinical record includes pain ratings. Per protocol, selection continued from charts until 12 patients treated with HFV and 12 treated without the use of HFV were obtained from each study center or until the potential subject pool of each investigator was exhausted. Subjects were eligible if: i) they received aligner treatment during the 1-year study period, and their completed in-office pain ratings were available in the clinical record, and ii) they have a history of healthy oral hygiene. Subjects were not eligible if: i) they were vulnerable subjects per IRB definitions, ii) they have concurrent caries, iii) they were non-compliant with HFV recommended daily usage, iv) they received periodontal therapy or medication within 6 months before the aligner treatment, or v) they received concurrent treatment with medications that could affect the level of inflammation, such as chronic antibiotics, phenytoin, cyclosporine, anti-inflammatory drugs, and systemic corticosteroids.

Experimental and control groups were administered an in-office, and at-home assessment. For the in-office assessment, experimental subjects received HFV using an exemplary embodiment of the device in FIG. 5 and control subjects did not receive HFV. Subjects in both groups were instructed to advance 2 aligners from current to ensure all subjects experienced some degree of pressure to measure relative change for a 5 minute period only, i.e. patient is on day 13 of tray 5 today, insert tray 7. Subject responses were documented on the NRS Numerical Rating Scale from 1 (no pain) to 10 (worst pain).

### Assessment I: In-Office

For the in-office assessment, pain was regularly assessed in the office at baseline, 3 minutes, and 5 minutes after placement. The experimental subjects received HFV and control subjects did not receive HFV. The outcome measures were subject reports of pain or discomfort on the NRS Numerical Rating Scale from 1 (no pain) to 10 (worst pain).

### Assessment II: At-Home

For the at-home assessment, experimental subjects received HFV and control subjects did not receive HFV. Subjects in both groups were instructed to document their responses on the NRS Numerical Rating Scale beginning with the first day of their next aligner change at baseline, then each day for 7 consecutive days. The outcome measures were subject reports of pain or discomfort on the NRS Numerical Rating Scale from 1 (no pain) to 10 (worst pain).

A total sample size of up to 24 charts in each practice (12 per group) to a total of 96 subjects for four study centers was requested for this study. The sample size was selected to yield 90% power to detect a difference if the true population difference (effect size) is equal to ⅔ of a standard deviation unit.

The primary analysis compared change in pain ratings from baseline, pooled across the post-baseline intervals, resulting in a single number per subject for the in-office data and a second value for the at-home data. These values were then compared between HFV treated subjects and controls with t-tests for independent samples. Supplemental testing included between-groups t-tests at each time point for illustrative purposes. Tests for sex differences were made by inspecting the treatment by sex interactions in 2-way ANOVAs. A significant criterion of p<0.05 was applied throughout.

This protocol was submitted and approved by an Institutional Review Board (IRB) prior to study initiation. Data gathered from subject charts were coded to maintain subject confidentiality and privacy.

Data were available and extracted from 75 subject charts (31 male/44 female). The experimental group comprised of 44 subjects (22 male/22 female) treated with HFV. The control group comprised of 31 subjects (9 male/22 female) treated with the traditional control treatment. There were no adverse events or unexpected adverse reactions associated with the use of the investigational device reported.

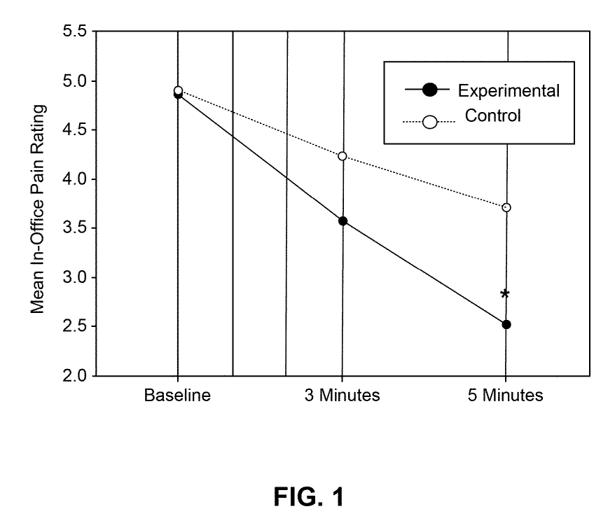

Referring to FIG. 1, complete in-office ratings were available for all subjects at baseline, 3 minutes, and 5 minutes after aligner placement. The mean in-office pain ratings are illustrated in FIG. 1. The experimental group (that received HFV using the exemplary device 300), illustrated by the solid line, showed an average decline of 1.82 points (SD=1.47) in reported pain ratings. The control group, illustrated by the dotted line, showed an average decline of 0.94 points (SD=1.05) in reported pain ratings. This difference between the experimental group and the control group was statistically significant (p=0.006). As illustrated in FIG. 1, the use of HFV treatment produces difference in pain ratings between the experimental group and the control group in less than 1 minute. In addition, the maximal difference between the groups was noted at the 5-minute time-point.

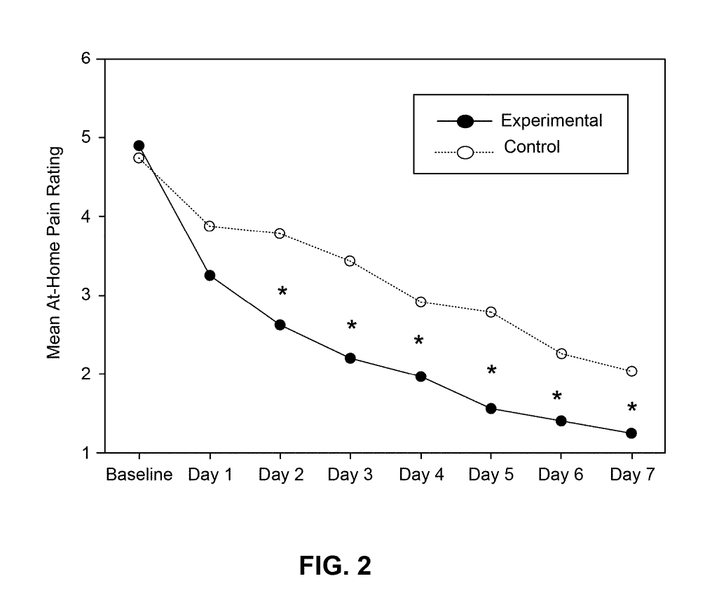

Referring to FIG. 2, at-home ratings were available for subjects with HFV treatment and 23 subjects with the control treatment. There were 542 data points recorded of the 544 expected (99.6% complete) for these pain ratings. The two missing data points were imputed by linear interpolation for the adjacent days in each case. The mean at-home pain ratings are illustrated in FIG. 2. The experimental group, illustrated by the solid line, showed an average decline of 2.86 points (SD=1.78) in reported pain ratings. The control group, illustrated by the dotted line, showed an average decline of 1.73 points (SD=1.72) in reported pain ratings. This difference between the experimental group and the control group was statistically significant (p=0.018). As illustrated in FIG. 2, the differences between the two groups were statistically significant starting from day 2 and on.

Two-way ANOVAs were used to test for sex differences in the efficacy of HFV as compared to control. If there was a differential response by sex, it would show up as an interaction effect in these ANOVAs. Based on the ANOVAs, the treatment by sex interaction was not significant for in-office (p=0.395) or at-home (p=0.143) data. Thus, no sex difference in efficacy was detected.

Subjects treated with HFV had all experienced the traditional treatment on prior aligner changes. When asked if they would recommend the exemplary device 300 to receive HFV, 37 of 44 subjects indicated that they would recommend, or strongly recommend use of the device 300. Six were indifferent and one did not respond.

Pain management is a concern in orthodontic treatment. The literature is replete with evidence of the negative impact discomfort has on compliance with the orthodontic treatment regimen (Krishnan 2007). Further, pain associated with orthodontic treatment is often underestimated by clinicians. A study by Krukemeyer reports that practitioners underestimate pain immediately following the last appointment by 43%, and 58.5% of patients agree or strongly agree with the statement, “I have pain for days after an appointment” (Krukemeyer 2009). With the nature of removable orthodontic appliances such as clear aligner therapy, managing it effectively is paramount. As reported by Keim, ‘pain management and even more important, pain prevention, are given short shrift in many orthodontic training programs’ (Keim 2004). Krishnan states that, ‘Many patients as well as parents consider initial lack of information about possible discomfort during treatment to be a major cause of the poor compliance exhibited” (Krishnan 2007). The literature further suggests that the patients’ initial attitude towards orthodontics should be understood during the diagnostic phase itself and should be discussed with the patients in all its reality (Krukemeyer 2009). ‘Setting the table’ at consult by preemptively addressing spoken, or unspoken concerns, as they relate to discomfort with options to manage it, may lead to a better patient experience, as well as improved compliance with therapy.

In this study, as seen in FIG. 1, HFV subjects (experimental group) demonstrated a rapid reduction in pain within 3 minutes immediately following an orthodontic adjustment. Furthermore, HFV subjects demonstrated a continuous decline in pain ratings to levels approaching no detectable pain, whereas control subjects' pain ratings demonstrated moderate pain with little relief. 30% of HFV patients reported 0 detectable discomfort within 5 minutes of HFV treatment. The extended effects of pain following an orthodontic adjustment, such as changing aligners in this study, were evident as well.

As seen in FIG. 2, HFV subjects' composite at-home pain rating at day 7 was 1.3, with 1 being no detectable pain. In fact, 77% of HFV patients had total elimination of pain while patients in the control group reported ongoing pain statistically significantly higher than that of HFV patients.

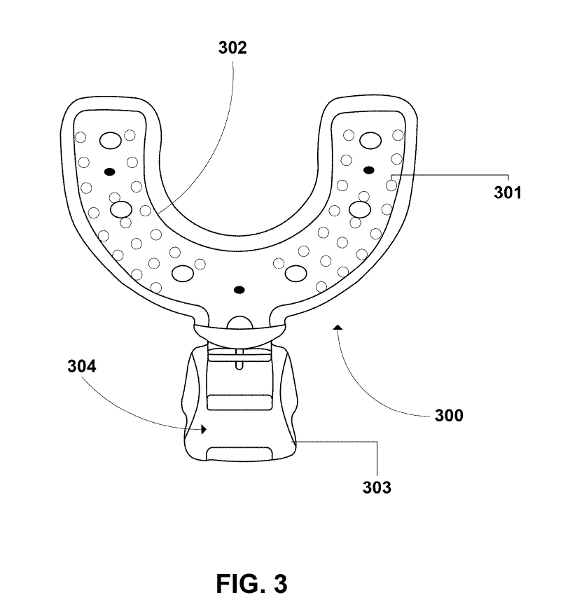

Referring to FIG. 3-7, the exemplary device 300 is an instrument to reduce oral discomfort in the mouth of a user. The exemplary device 300 can be used to deliver high frequency vibration to the dentition of the user to reduce discomfort. The vibration delivered to the dentition of the user can be adjusted. In some embodiments, the exemplary device 300 can be used to deliver vibration at a frequency range of about 80 Hz to about 120 Hz. In another embodiment, the exemplary device 300 can be used to deliver vibration at a frequency of about 100 Hz. In another embodiment, the device 300 can be used to deliver vibration at a frequency of about 120 Hz. The vibration delivered to the dentition of the user can have an acceleration magnitude between about 0.03 G and about 0.2 G. The acceleration magnitude of the vibration of the vibration unit can, also, be adjusted. The exemplary device 300 can be used for less than about 20 minutes, for example for about 5 minutes daily.

The exemplary device 300 can, also, be used to accelerate tooth movement thereby reducing the overall duration of the orthodontic treatment. The exemplary device 300 can be used to accelerate the goal of retention, which is reaching stable occlusion, by increasing bone density faster, promoting faster relaxation of the periodontal ligament (PDL) fibers, and decreasing relapse when worn consistently. The exemplary device 300 can further be used to aid in the growth of bone in the mouth by restoring alveolar bone that may be previously lost due to bad oral health. The exemplary device 300 can, also, be used to reduce pain and discomfort by providing better aligner seating. By providing better aligner seating, the exemplary device 300 can improve distribution of forces on the user's teeth and allow better tracking of teeth movement.

Referring to FIG. 3, the exemplary device 300 includes a mouthpiece 302 and a mouthpiece connector 304. The mouthpiece 302 can have a proximal end 301 and a distal end 303. The proximal end 301 can be placed intraorally into the mouth of the user in order to place the mouthpiece 302 in vibrational contact with the dentition of the user. The distal end 303 of the mouthpiece 302 can be removably coupled to a vibration unit. The mouthpiece 302 can be C-shaped (or U-shaped) in order to allow comfortable fitting inside the user's mouth. The mouthpiece 302 can be water-resistant so that the mouthpiece can be removed and cleaned with water. The mouthpiece 302 can be made with a soft material that allows for improved user comfort when using the device 300. The mouthpiece 302 can be placed inside the user's mouth, preferably on the occlusal surface of the user's teeth. The mouthpiece 302 can also be placed on the labial or lingual surfaces of the user's teeth. The mouthpiece 302 can be place intraorally into vibrational contact with the dentition of the user.

The mouthpiece 302 can further include a motor (not shown) that is installed in the mouthpiece connector 304. The motor can be installed in the mouthpiece connector 304, the housing connector 310 (FIG. 4), or the housing 306 (FIG. 4). The mouthpiece connector 304, the housing connector 310 (FIG. 4), or the housing 306 (FIG. 4) can also include electronic circuitries (not shown), including a control circuitry and a power circuitry for operating the motor. The motor may be any type of motor that can cause mouthpiece 302 or the proximal end 301 to vibrate. For example, the motor can be a vibration motor, piezoelectric motor, a linear motor, or an electromagnetic motor. The frequency and/or acceleration magnitude of vibration caused by the motor can be adjusted by change the voltage or current supplied to the motor by electronic circuitries. For example, the voltage used for operating the motor may range from about 0.5 volt to about 4 volts. The current supplied to an exemplary motor may range from about 65 mA to about 100 mA.

In some embodiments, the motor can be configured to vibrate mouthpiece 302 at a frequency higher than about 80 Hz, such as at a frequency between about 100 Hz to about 120 Hz. The motor can be further configured to vibrate mouthpiece 302 at an acceleration magnitude ranging between about 0.03 G and about 0.2 G. As described herein, the vibrational frequency of mouthpiece 320 may vary from the rated “free-air” vibrational frequency of the motor due to the amount of biting force or load applied to mouthpiece 302, such as the force used to clamp the exemplary device 300 in place. For example, when the motor is configured to vibrate at a frequency of about 120 Hz, adding biting force or load to mouthpiece 302 may result in a lower vibrational frequency of mouthpiece 302 ranging from about 100 Hz to about 120 Hz.

The exemplary device 300 can be used while the user is undergoing orthodontic treatment. For example, the user can be wearing bracket-and-wire braces, in which case the mouthpiece 302 may be in direct contact with at least a portion of the user's dentition. In other embodiments, the user can be wearing at least one aligner, in which case the mouthpiece 302 may be in vibrational contact with at least a portion of the user's dentition through the at least one aligner. In another embodiment, the exemplary device 300 can be used after the user has taken off the braces or aligners and when the user is not wearing any braces or aligners. For example, the exemplary device 300 can be used to reduce oral discomfort after a user has undergone a recent oral surgery, such as receiving an implant.

Referring to FIG. 4, the exemplary device 300 includes a housing 306 that comprises a vibration unit (not shown), a button 308, and a housing connector 310. The vibration unit can be activated in order to deliver high frequency vibration to the user's dentition. The vibration unit can be activated or deactivated when the user depresses a button 308. The user may be able to pause and resume the vibration unit in the middle of a treatment cycle by depressing the button 308. The vibration unit can, also, be deactivated automatically after a predetermined period of time has passed. In a preferred embodiment, the predetermined period of time is less than about 20 minutes, for example about 5 minutes before the vibration unit deactivates automatically.

The vibration unit can be activated after the user has placed the mouthpiece 302 intraorally into vibrational contact with the dentition of a user. In another embodiment, the vibration unit can be activated before the user places the mouthpiece 302 intraorally into vibrational contact with the dentition of a user.

The housing connector 310 can be removably coupled to the mouthpiece connector 304 (FIG. 3). The exterior surface of the housing connector 310 can be shaped so that it corresponds to the interior surface of the mouthpiece connector 304.

FIG. 5 shows an embodiment of the exemplary device 300 comprising a mouthpiece 302 removably coupled to the housing 306. The mouthpiece 302 and the housing 306 may be coupled by a joining of the mouthpiece connector 304 and the housing connector 310. The exemplary device 300 can be portable and hand-held so that the user can receive vibrational treatment while performing daily tasks. Therefore, the treatment may not interfere with the user's schedule and increase compliance rate.

FIG. 6 shows another view of the exemplary device 300 comprising a status light 312. The status light 312 can be LED lights. The status lights 312 can indicate to the user or notify the user the progress of each treatment cycle. For example, the status lights 312 can notify the user when a 5-minute cycle is in progress, when a user presses a switch button before treatment is complete, when a 5-minute treatment cycle is interrupted and not completed within a 30-minute time window, when the device is plugged in to a power source, when the battery is low, when the device is fully charged, when the 5-minute treatment cycle is interrupted and the user plugs the device into a USB connection within the 30-minute time window, and when device is on/vibrating and the user plugs the device into a USB connection thereby stopping the vibration. The status light 312 can vary in color. For example, the status light 312 can produce blue, green, red, magenta, or amber colored lights. In addition, the status light 312 can produce a blinking light or a continuous light. In some embodiments, the status light 312 can blink at least 3 times in order to indicate a status of the treatment cycle. In other embodiments, the status light 312 can blink at least 6 times in order to indicate a status of the treatment cycle.

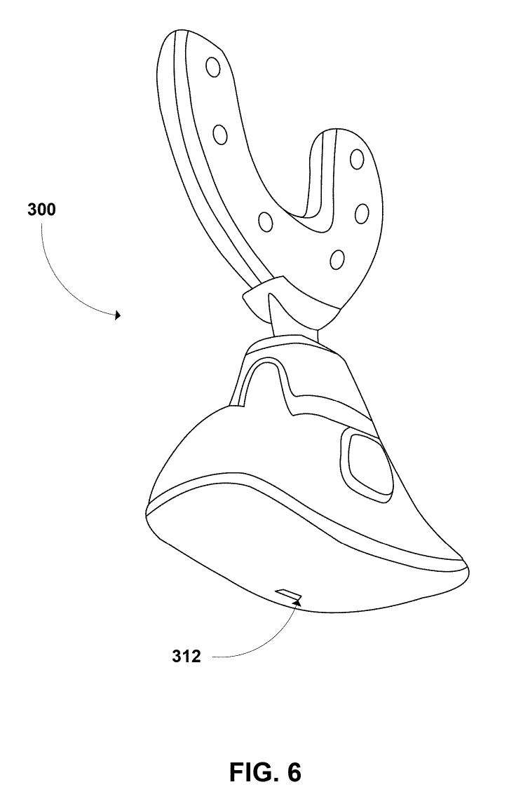

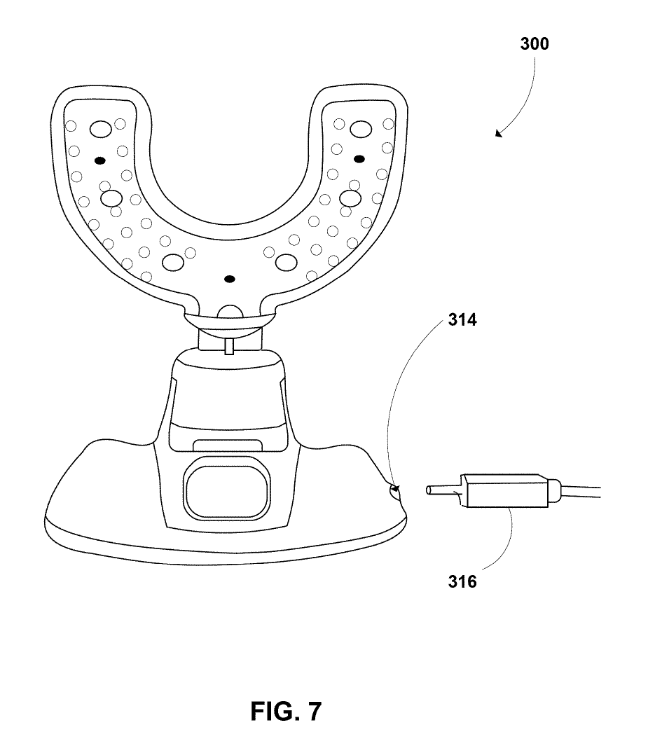

Referring to FIG. 7, the exemplary device 300 can be removably coupled to a charging cable 316 via a port 314. The port 314 may be shaped to correspond to the shape of at least the portion charging cable 316 configured to removably couple to the port 314. The charging cable could be a USB cable or any other cable that is capable of fitting inside the port 314 and providing electrical connection between the vibration unit of the housing 306 (FIG. 5) and a power source (not shown). The other end of the charging cable 316 can be removably coupled to a power source, which can be a wall adapter or a remote device.

A simulation was conducted to test and compare the vibration characteristics of a typodont caused by an exemplary embodiment of device 300 and a commercially available dental device, the AcceleDent Aura™. In the simulation setup, the typodont was secured to a metal table. The upper jaw of the typodont was hinged to the lower jaw and capable of opening and closing. Each device was placed in the typodont (between the occlusal surfaces) and held in position by securely mounting a weight of about 0 to about 4 pounds on the upper jaw. The weight simulates the biting force typically applied by a user to clamp the devices in place.

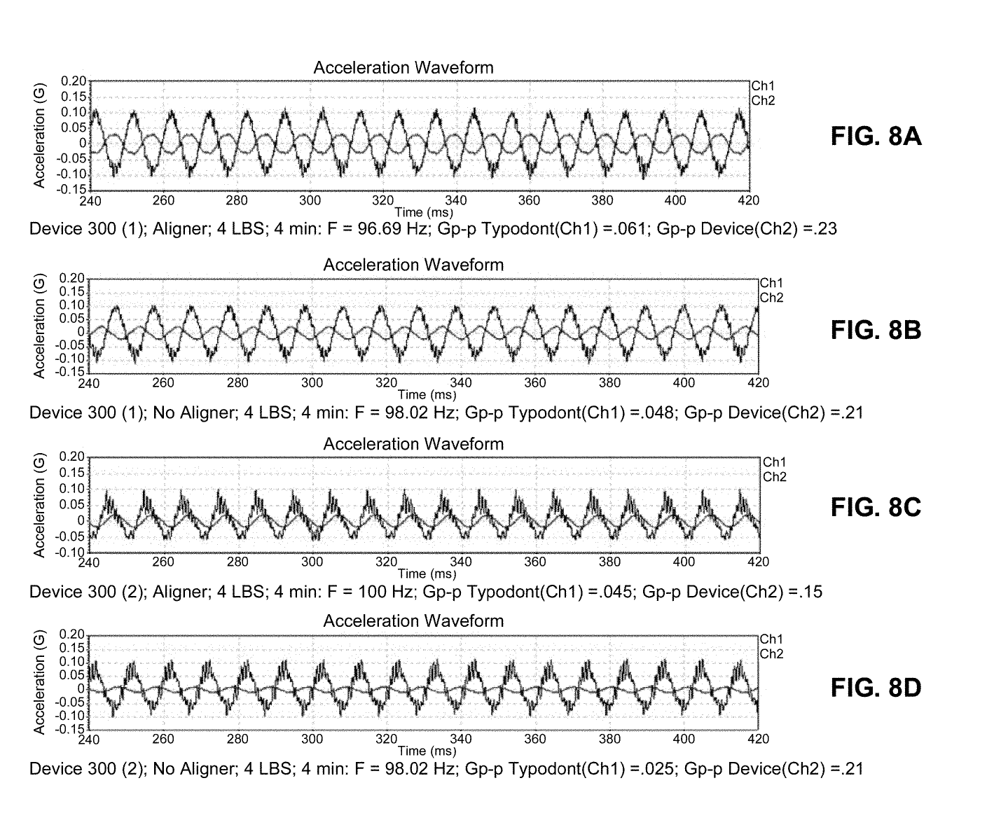

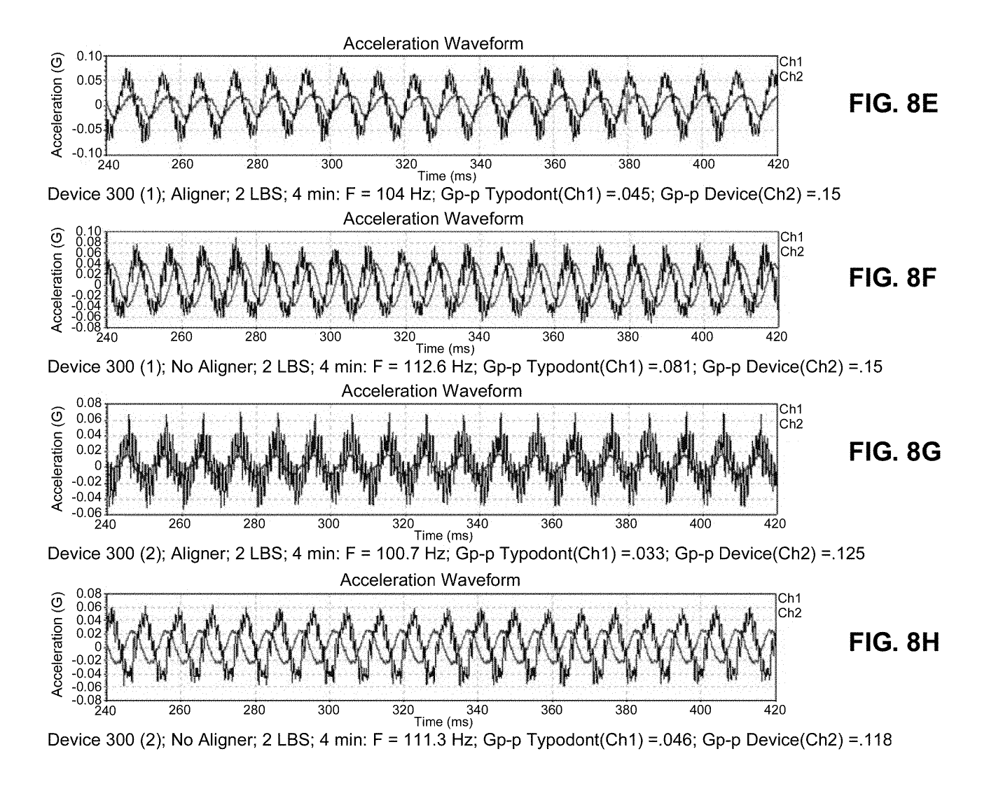

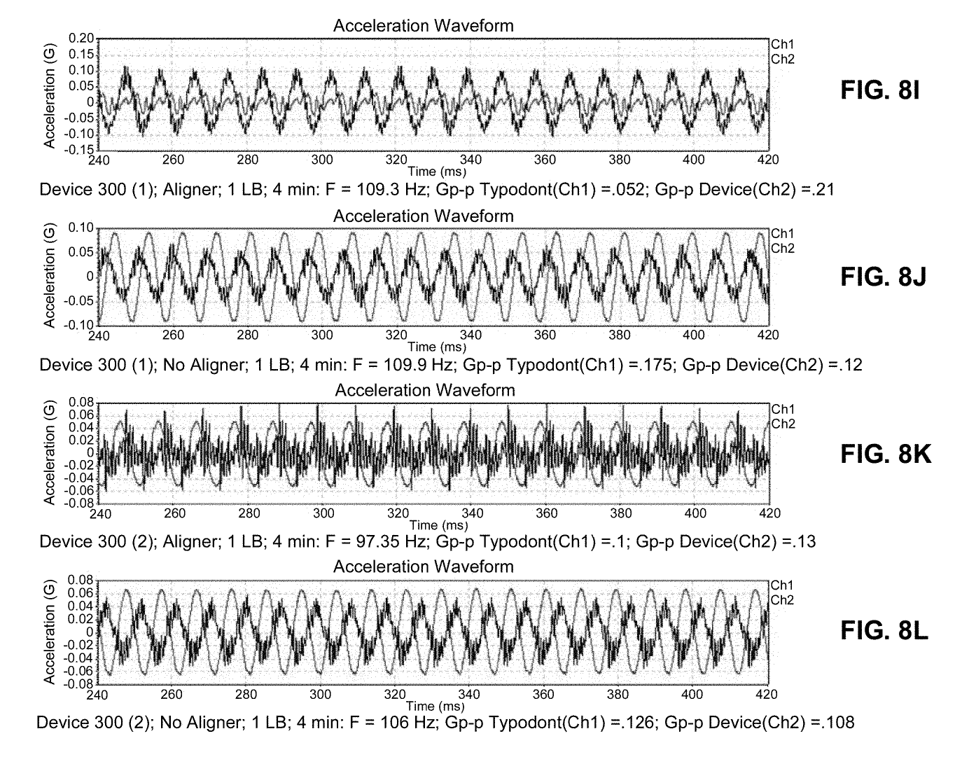

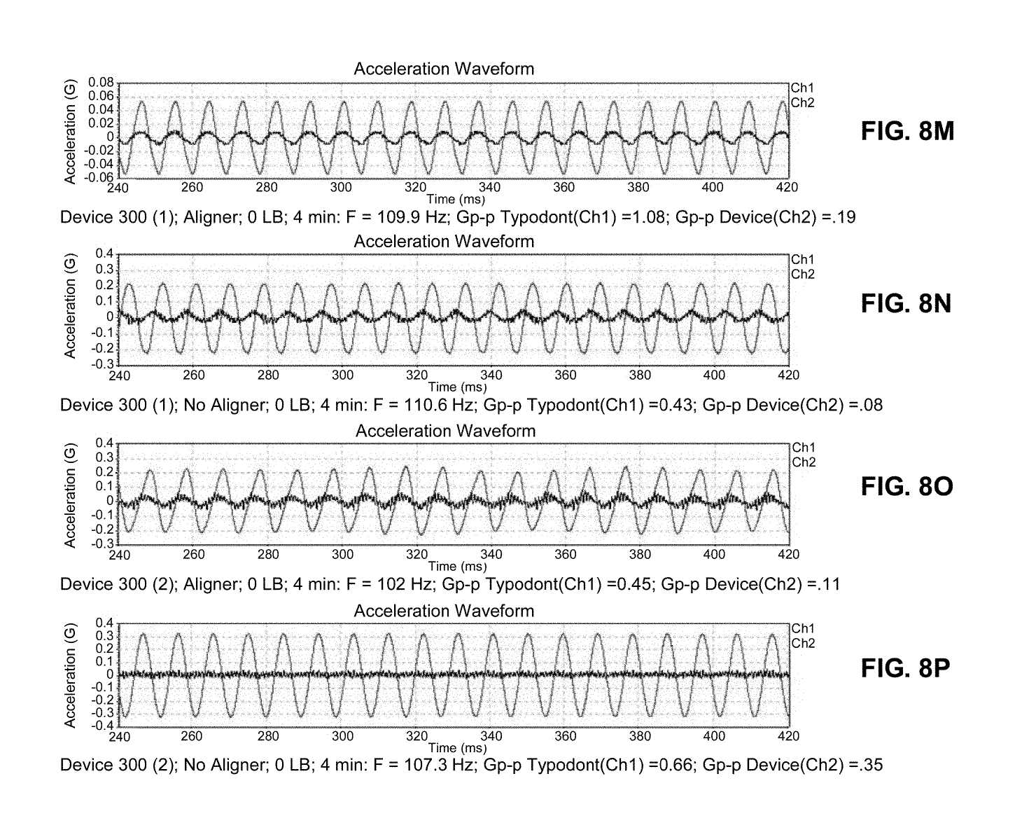

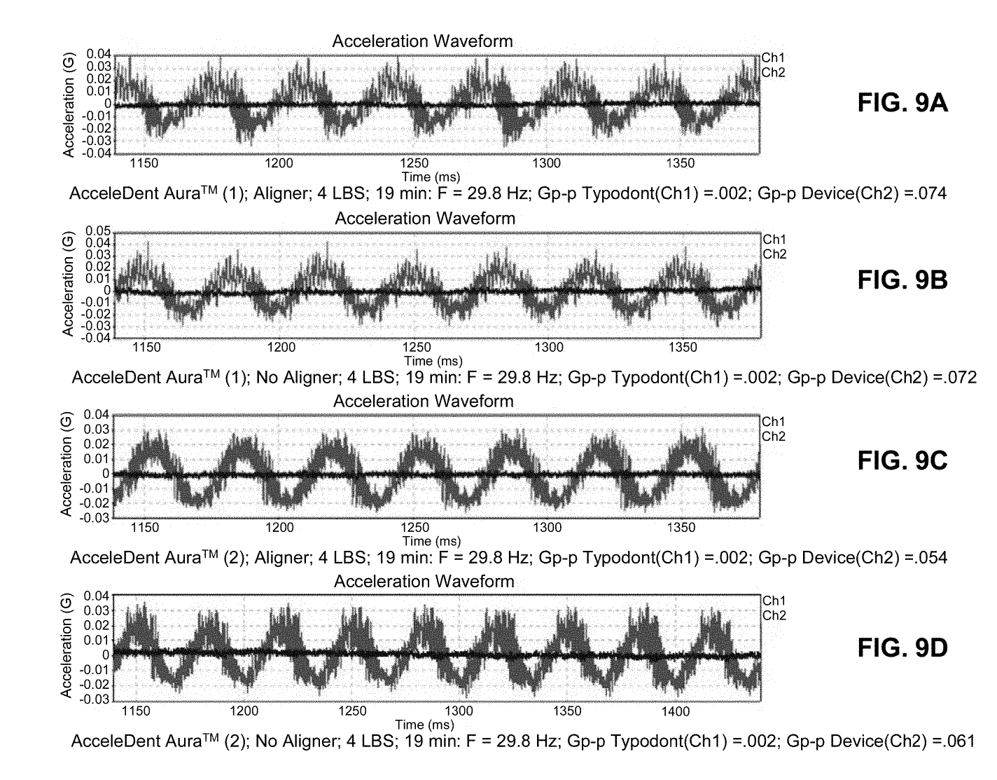

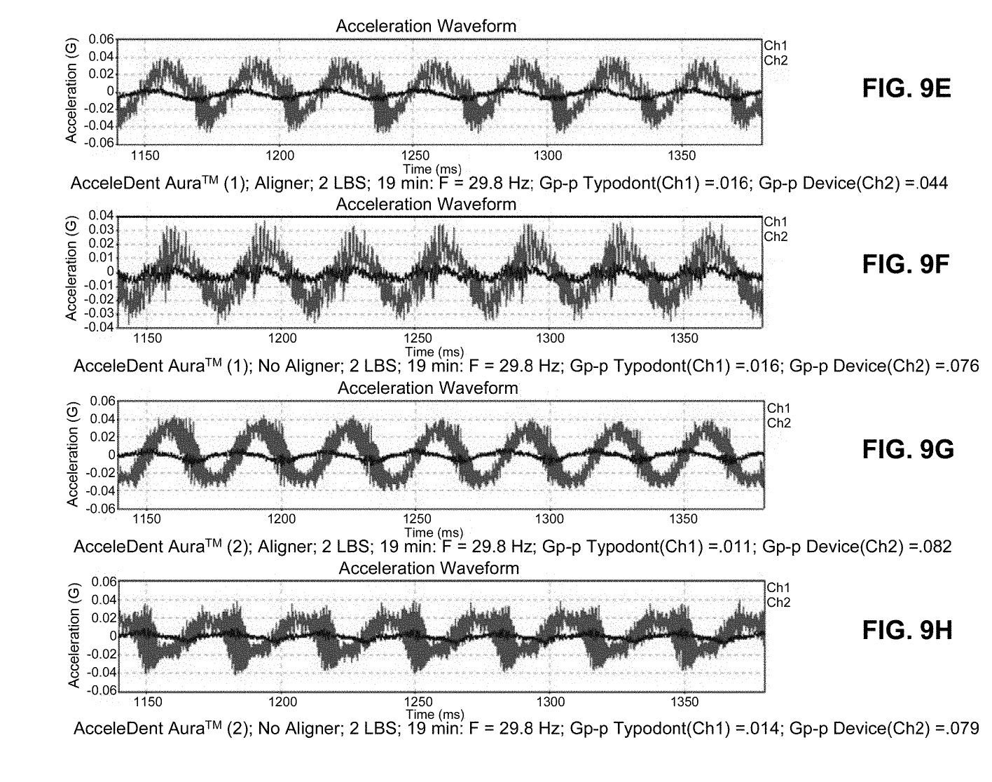

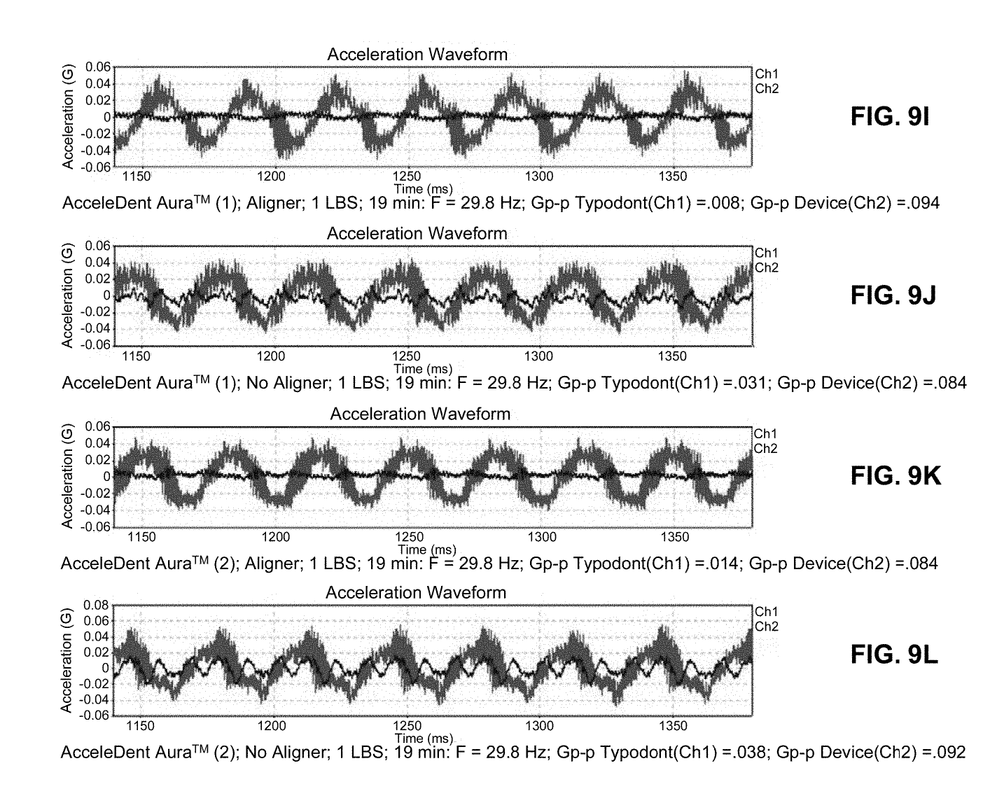

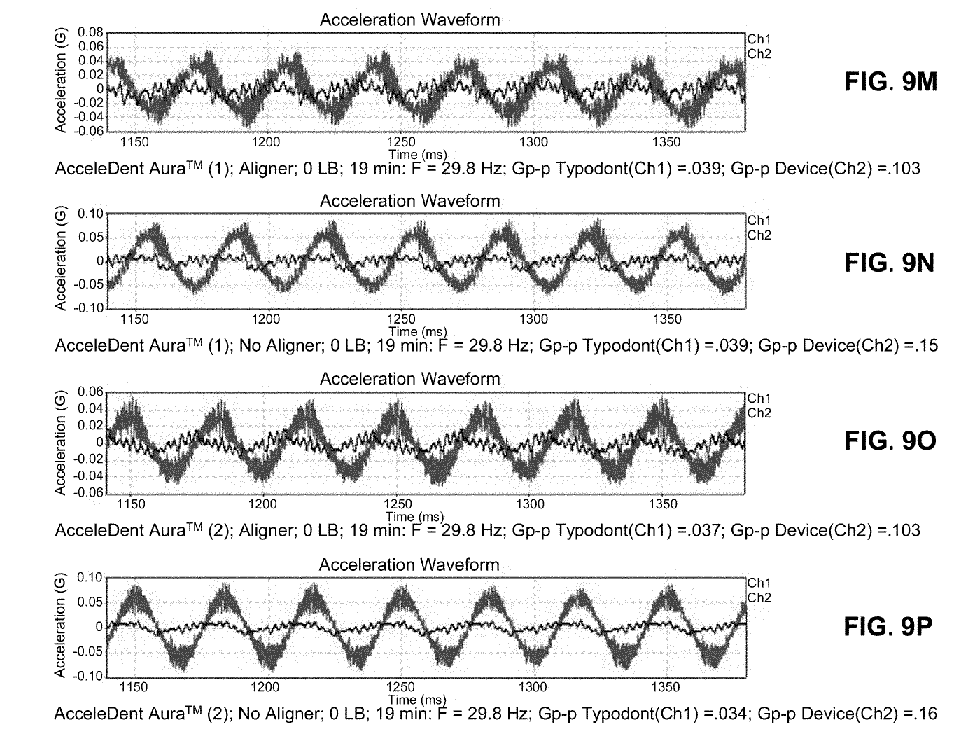

The simulation setup further included electronic instruments, including accelerometers, for measuring vibration characteristics of the typodont. The accelerometers were placed directly on the devices and on the typodont. FIGS. 8A-9P each show the measurement dataset of the accelerometer for two channels, channel 1 (“Ch1”) for detecting the vibration characteristics of the typodont and channel 2 (“Ch2”) for detecting the vibration characteristics of the device. As shown in FIGS. 8A-9P, measurements of the accelerometers over the operation time of each device recorded increasing and decreasing accelerations of the devices and the typodont. The measurement dataset of the accelerometers resembles a sinusoidal curve. The distance from the bottom to the top of the sinusoidal curve is called the peak-to-peak G value or g-force (Gₚ₋ₚ).

In this simulation, the operation time of the exemplary device 300 was about 5 minutes. The operation time of AcceleDent Aura™ was about 20 minutes. The maximum Gₚ₋ₚ values of the vibration of the typodont actuated by these two devices under different simulated biting forces (different weights) were measured using the accelerometers and other associated electronic instruments about one minute before the end of the operation time. Therefore, measurement of the frequency and g-force for each channel was performed at the time point of about 4 minutes for the exemplary device 300 and at the time point of about 19 minutes for AcceleDent Aura™.

The simulation was repeated for a second testing device of the exemplary device 300 and a second testing device of AcceleDent Aura™. Therefore, the first and second exemplary devices 300 tested are shown as device 300 (1) and device 300 (2), respectively in FIGS. 8A-8P. Also, the first and second AcceleDent Aura™ devices are shown as AcceleDent Aura™ (1) and AcceleDent Aura™ (2) respectively in FIGS. 9A-9P. The simulation was also repeated where the typodont was installed with and without an aligner, as indicated in the captions of FIGS. 8A-9P. All measurement data was summarized in Table 1 as shown below.

TABLE 1
G-force values (Gₚ₋ₚ) measured under different testing conditions.

| | | | | | g-force | g-force |
|---|---|---|---|---|---|---|
| | | | | | on | on |
| | | | | Frequency | typodont | device |
| Device | Weight | Aligner | Time | (Hz) | (G) | (G) |
| AcceleDent Aura ™ (1) | 4 | Yes | End-1 Min | 29.8 | 0.002 | 0.074 |
| AcceleDent Aura ™ (1) | 4 | No | End-1 Min | 30.46 | 0.002 | 0.072 |
| Device 300 (1) | 4 | Yes | End-1 Min | 96.69 | 0.061 | 0.230 |
| Device 300 (1) | 4 | No | End-1 Min | 98.02 | 0.048 | 0.210 |
| AcceleDent Aura ™ (2) | 4 | Yes | End-1 Min | 29.8 | 0.002 | 0.054 |
| AcceleDent Aura ™ (2) | 4 | No | End-1 Min | 29.8 | 0.002 | 0.061 |
| Device 300 (2) | 4 | Yes | End-1 Min | 100 | 0.045 | 0.150 |
| Device 300 (2) | 4 | No | End-1 Min | 98.02 | 0.025 | 0.210 |
| AcceleDent Aura ™ (1) | 2 | Yes | End-1 Min | 29.8 | 0.016 | 0.084 |
| AcceleDent Aura ™ (1) | 2 | No | End-1 Min | 29.8 | 0.016 | 0.076 |
| Device 300 (1) | 2 | Yes | End-1 Min | 104 | 0.045 | 0.150 |
| Device 300 (1) | 2 | No | End-1 Min | 112.6 | 0.081 | 0.150 |
| AcceleDent Aura ™ (2) | 2 | Yes | End-1 Min | 29.8 | 0.011 | 0.082 |
| AcceleDent Aura ™ (2) | 2 | No | End-1 Min | 29.8 | 0.014 | 0.079 |
| Device 300 (2) | 2 | Yes | End-1 Min | 100.7 | 0.033 | 0.125 |
| Device 300 (2) | 2 | No | End-1 Min | 111.3 | 0.046 | 0.118 |
| AcceleDent Aura ™ (1) | 1 | Yes | End-1 Min | 29.8 | 0.008 | 0.094 |
| AcceleDent Aura ™ (1) | 1 | No | End-1 Min | 29.8 | 0.031 | 0.086 |
| Device 300 (1) | 1 | Yes | End-1 Min | 109.3 | 0.052 | 0.210 |
| Device 300 (1) | 1 | No | End-1 Min | 109.9 | 0.175 | 0.120 |
| AcceleDent Aura ™ (2) | 1 | Yes | End-1 Min | 29.8 | 0.014 | 0.084 |
| AcceleDent Aura ™ (2) | 1 | No | End-1 Min | 29.8 | 0.038 | 0.092 |
| Device 300 (2) | 1 | Yes | End-1 Min | 97.35 | 0.100 | 0.130 |
| Device 300 (2) | 1 | No | End-1 Min | 106 | 0.126 | 0.108 |

In exemplary embodiments, the exemplary device 300 can be configured to deliver g-forces above those found in prior art devices indicated for use with aligners or without aligners.

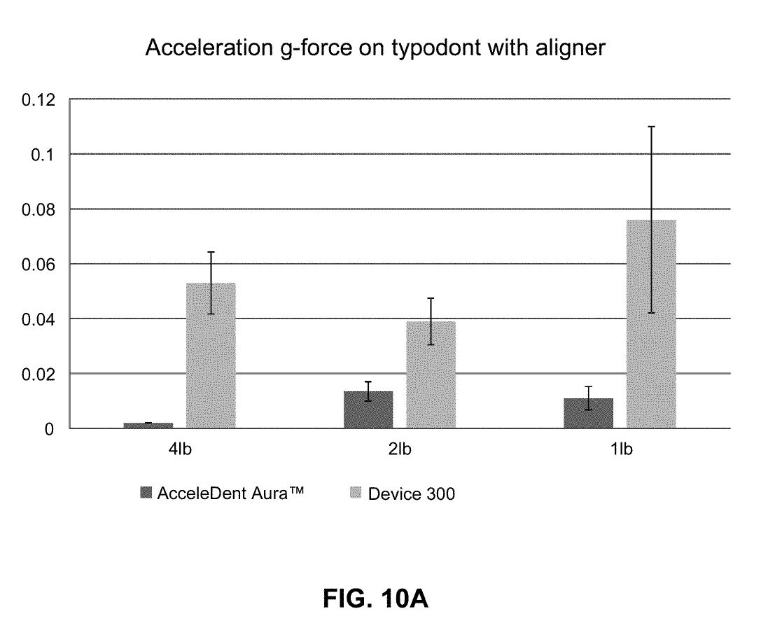

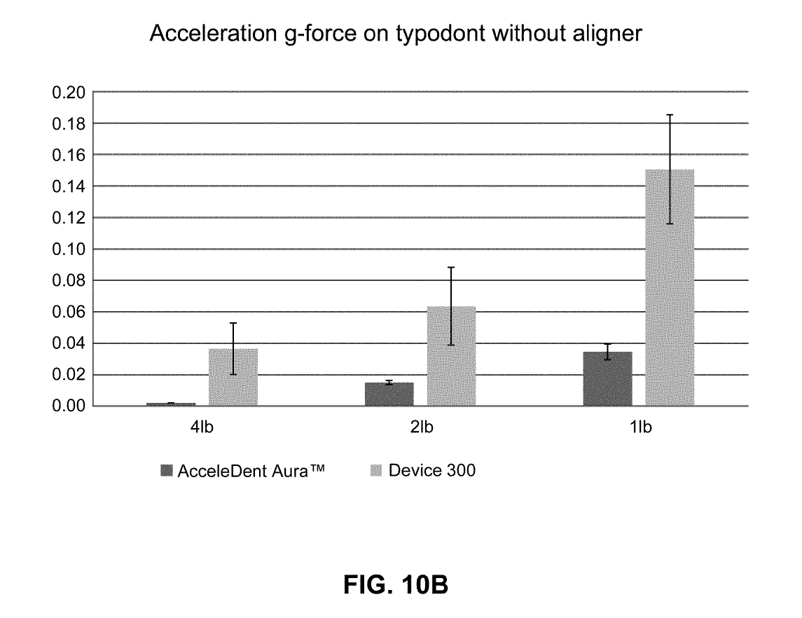

FIG. 10A and Table 2 show the measured g-force values (Gₚ₋ₚ) of the typodont mounted with different weights while subject to vibration by the exemplary device 300 and by the AcceleDent Aura™ with the aligner. FIG. 10B and Table 3 shows the measured g-force values (Gₚ₋ₚ) of the typodont mounted with different weights while subject to vibration by the exemplary device 300 and by the AcceleDent Aura™ without the aligner. As described herein, results shown in FIGS. 10A and 10B and Tables 1 and 2 were average values and standard deviations of the measured g-force values (Gₚ₋ₚ) on the typodont caused by the two testing devices of the exemplary device 300 and the two testing devices of AcceleDent Aura™.

As shown in FIGS. 10A and 10B, the exemplary device 300 produced greater acceleration than the AcceleDent Aura™ at various simulated biting forces (under various weights). When the typodont was fitted an aligner (as shown in FIG. 10A and Table 1), depending on the simulated biting force, the AcceleDent Aura™ caused very low acceleration levels of the typodont with g-force values from less than about 0.01 G to no greater than about 0.02 G. In contrast, the exemplary device 300 resulted in higher acceleration levels of the typodont with g-force values ranging from about 0.04 G to about 0.076 G. In particular, the two-pound and four-pound weights (or simulated biting force) caused the AcceleDent Aura™'s measured average g-force values to drop to very low levels of about 0.0135 G and about 0.002 G, respectively. When the typodont was without an aligner (as shown in FIG. 10B and Table 2), depending on the simulated biting force, the AcceleDent Aura™ similarly caused very low acceleration levels with g-force values from less than about 0.01 G to no greater than about 0.04 G. Again, in contrast, the exemplary device 300 resulted in multi-fold higher acceleration levels with g-force values ranging from about 0.04G to about 0.15 G.

These results suggest that the exemplary device 300 can produce greater acceleration magnitude of the typodont under different simulated biting forces than the AcceleDent Aura™ with or without aligners.

TABLE 2
Average g-force values (Gₚ₋ₚ) of the typodont mounted with
different weights while subject to vibration by the exemplary
device 300 and by the AcceleDent Aura ™ with the aligner.

| | 4 lb | | 2 lb | | 1 lb | |
|---|---|---|---|---|---|---|
| Device | Average | SD | Average | SD | Average | SD |
| AcceleDent | 0.002 | 0.0000 | 0.0135 | 0.0035 | 0.011 | 0.0042 |
| Aura ™ | | | | | | |
| Device 300 | 0.053 | 0.0113 | 0.0390 | 0.0085 | 0.076 | 0.0339 |

TABLE 3
Average g-force values (Gₚ₋ₚ) of the typodont mounted with different
weights while subject to vibration by the exemplary device 300
and by the AcceleDent Aura ™ without the aligner.

| | 4 lb | | 2 lb | | 1 lb | |
|---|---|---|---|---|---|---|
| Device | Average | SD | Average | SD | Average | SD |
| AcceleDent | 0.0020 | 0.0000 | 0.0150 | 0.0014 | 0.0345 | 0.0049 |
| Aura ™ | | | | | | |
| Device 300 | 0.0365 | 0.0163 | 0.0635 | 0.0247 | 0.1505 | 0.0346 |

The topic of orthodontic pain has ramifications that extend beyond patient comfort, and ripple through practice efficiency and profitability. Direct impacts of reported pain may be cross-referenced through reports on compliance with appointments, compliance with regiment and referral rate of siblings, family members, and friends. However, indirect impacts of patient comfort as it relates to treatment compliance often go undetected. They may present themselves through increased administration overhead on scheduling, impacts on treatment acceptance related to fear of pain, loss of revenue due to open chair time, and/or additional treatment visits required. A growing intangible is the patient sharing of experiences through social media.

The retrospective studies herein show improvement in mean pain ratings after aligner adjustment when traditional treatment is combined with HFV treatment. According to the second retrospective study mentioned herein, the magnitude of improvement was 67% of a pooled standard deviation unit for in-office ratings and 64% of a pooled standard deviation unit for at-home ratings. These differences fall between the criteria for moderate and large effects, which indicate that these differences are clinically meaningful effects. Pain and discomfort were reduced equally independent of gender. Regarding patient compliance rate, 542 of 544 data points returned from at-home survey demonstrated a remarkable daily compliance rate of 99.6%.

The study, therefore, demonstrates that HFV is an effective treatment to reduce orthodontic pain and discomfort without supplemental pharmacological analgesia. Near perfect compliance shows that less than about 20 minutes, for example about 5 minutes, of HFV treatment was not an interference to the subjects' daily schedules, which may directly and indirectly contribute to improved patient experience, increased practice efficiency, and increased overall profitability. Further, the device configured to provide HFV treatment described herein can be performed in-office and at-home with improved patient comfort.

It will be appreciated that while particular embodiments of the invention have been shown and described, modifications may be made. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. It is intended in the claims to cover the modifications which come within the spirit and scope of the invention.

Each of the following is incorporated by reference in its entirety.
Woodhouse N., Supplemental vibrational force does not reduce pain experience during initial alignment with fixed orthodontic appliances: a multicenter randomized clinical trial. Scientific Reports 2015 Nov.; 5 :17224.
Ottoson D., Vibratory stimulation for the relief of pain of dental origin. Pain 1981 Feb.; 10 (1):37-45.
Lala A., Vibration therapy in orthodontics: Realizing the benefits. Ortho 2016; 1:24-27.
Long H., Current advances in orthodontic pain. International Journal of Oral Science 2016, 8:67-75.
Tan D., The Effect of Mechanical Vibration (Acceledent, 30 Hz) applied to the hemimaxilla on Root Resorption Associated with Orthodontic Force—A Micro-CT Study. 2011.
Krishnan V., Orthodontic pain: from causes to management—a review. European Journal of Orthodontics 29; 170-179.
Krukemeyer A., Pain and Orthodontic Treatment. Angle Orthodontist 2009, Vol. 79, No. 6.
Keim R., Managing Orthodontic Pain. 2004, JCO Volume 38:12; 641-642.
Woodhouse et al., Supplemental Vibrational force during orthodontic alignment: a randomized trial. J Dent Res. 2015; 94(5):682-9.
Miles et al., The effects of a vibrational appliance on tooth movement and patient discomfort: a prospective randomized clinical trial. Aust Orthod J. 2012; 28(2):213-18.
Marie et al., Vibratory stimulation as a method of reducing pain after orthodontic appliance adjustment. J Olin Orthod. 2003; 37(4):205-8; quiz 3-4.

1. A method of reducing oral discomfort in a user, the method comprising:
(a) placing a proximal end of a mouthpiece intraorally into vibrational contact with a dentition of the user;
(b) activating a vibration unit so as to deliver vibration at a frequency higher than about 80 Hz and at a g-force between about 0.03 G and about 0.2 G to the dentition of the user; and
(c) removing the vibration unit after about 5 minutes; wherein oral discomfort is reduced compared to a time preceding step (b).

2. (canceled)

3. The method of claim 1, further comprising delivering vibration at a frequency between about 100 Hz and about 120 Hz.

4. (canceled)

5. The method of claim 1, further comprising adjusting the frequency or g-force of the vibration of the vibration unit.

6. The method of claim 1, wherein the step of activating or deactivating the vibration unit further comprises depressing a button on the vibration unit.

7. The method of claim 1, wherein step (c) is performed after the vibration unit automatically deactivates after about 5 minutes.

8. The method of claim 1, wherein the user is undergoing orthodontic treatment

9. The method of claim 8, wherein the user is wearing bracket-and-wire braces, and the mouthpiece is in direct contact with at least a portion of the dentition of the user.

10. The method of claim 8, wherein the user is wearing at least one aligner, and the mouthpiece is in vibrational contact with at least a portion of the dentition of the user through the at least one aligner.

11. The method of claim 1, further comprising a step of removably coupling a distal end of a mouthpiece to a housing comprising the vibration unit before step (b).

12. The method of claim 1, wherein step (b) is performed before step (a).

13. A device for reducing oral discomfort in a user, the device comprising:
a mouthpiece comprising a proximal end configured to be placed intraorally into vibrational contact with a dentition of the user; and
a vibration unit configured to deliver vibration at a frequency higher than about 80 Hz and at a q-force between about 0.03 G and about 0.2 G to the dentition of the user after activation,
wherein the vibration unit is further configured to be removed after about 5 minutes, and
wherein oral discomfort is reduced compared to a time before activation of the vibration unit.

14. (canceled)

15. The device of claim 13, wherein the vibration unit is configured to vibrate at a frequency between about 100 Hz and about 120 Hz.

16. (canceled)

17. The device of claim 13, further comprising a button configured to be depressed in order to activate or deactivate the vibration unit.

18. The device of claim 13, wherein the user is undergoing orthodontic treatment

19. The device of claim 18, wherein the user is wearing bracket-and-wire braces, and the mouthpiece is in direct contact with at least a portion of the dentition of the user.

20. The device of claim 18, wherein the user is wearing at least one aligner, and the mouthpiece is in vibrational contact with at least a portion of the dentition of the user through the at least one aligner.
